(19) United States
(12) Patent Application Publication
(10) Pub. No.: US 2022/0075349 A1
(43) Pub. Date: Mar. 10, 2022

(54) METHOD AND APPARATUS FOR MULTI-CORE PROCESSOR MANAGEMENT IN A MOTION CONTROL SYSTEM

(71) Applicant: Delta Tau Data Systems, Inc., Chatsworth, CA (US)

(72) Inventors: Atul R Govande, Simi Valley, CA (US); Dro Ghazarian, Glendale, CA (US); Henry Bausley, Los Angeles, CA (US); Ed Lay, Venture, CA (US)

(21) Appl. No.: 17/014,510

(22) Filed: Sep. 8, 2020

(51) Int. Cl. G05B 19/4155

(52) U.S. Cl. CPC G05B 19/4155; G05B 2219/33116

(57) ABSTRACT

According to techniques disclosed herein, a motion control program for execution on a multi-core processor of a motion control system includes multiple task types or task classes, with different ones of the task types divided among the respective processing cores of the multi-core processor. For example, the division depends on user input or on assessing the expected or measured performance of the involved motion control program. Assigning a type or class of tasks to a respective processing core results in a mapping the lower-level executable instructions that represent the type or class of task to a target one of the processing cores. However, dividing the task types or classes among the processing cores at the abstraction level of the motion control program advantageously provides for tailoring the processing-core assignments to the characteristics or needs of the motion-control problem embodied in the motion control program.

### TECHNICAL FIELD

The techniques disclosed herein relate to motion control systems and particularly relate to management of multi-core processors in motion control systems.

### BACKGROUND

“Motion control” refers to the automated control of machine movement, such as used in precision machining or manufacturing, with motion control often involving velocity and acceleration control of machine parts along a planned trajectory involving one or more axes of motion. In a simplified example, a motion control system generates output control signals for one or more amplifiers that drives respective motors that impart linear or rotary motion to machine parts, with the motion control system receiving feedback signals allowing it to track positions and speeds of the driven motors.

Motion control entails a variety of complex program tasks, such as path planning and servo control, including receiving and processing feedback signals that allow the involved motion control system to determine errors in position, velocity, and acceleration of the machine part(s) being controlled. Oftentimes, the overall motion-control problem involves multi-axis control of high complexity and imposes significant computational burdens limited by real-time control considerations.

Adding to the overall computing burden, motion-control systems generally offer high levels of customization in the sense that an end user programs the motion control system to operate in situ in a specific machine-control environment, such that the motion control program executed by the machine control system includes a variety of task types or classes of tasks. Some tasks or classes of tasks are explicitly part of the motion-control problem being solved, while other tasks or classes of tasks are not explicit motion-control operations but rather involve associated monitoring or communication tasks needed to integrate the motion control system into a larger automation network. For example, the program tasks or task classes include background tasks that may be related to or ancillary to the explicit motion-control tasks.

One approach to ensuring the performance of machine control programs involves the use of multi-core processors in the machine control systems tasked with executing the machine control programs. For example, the LS1043A processor by NXP is a 64-bit, ARM-based processor that includes four processing cores, large cache memories, and multiple high-speed communication interfaces.

However, as recognized herein, even with the use of multi-core processors in the motion control systems that execute machine control programs, effective core management of the multiple processing cores is lacking. For example, the operating system or other processes running on a multi-core processor may provide at least some load balancing among the multiple processing cores. Such balancing does not optimize or otherwise consider the program tasks at the higher, abstract level of the machine control program, wherein there are various types or classes of tasks, including different kinds of task types directly involved in the motion control processing and different kinds of task types that are ancillary or supplemental to the motion control processing.

### SUMMARY

According to techniques disclosed herein, a motion control program for execution on a multi-core processor of a motion control system includes multiple task types or task classes, with different ones of the task types divided among the respective processing cores of the multi-core processor. For example, the division depends on user input or on assessing the expected or measured performance of the involved motion control program. Assigning a type or class of tasks to a respective processing core results in a mapping the lower-level executable instructions that represent the type or class of task to a target one of the processing cores. However, dividing the task types or classes among the processing cores at the abstraction level of the motion control program advantageously provides for tailoring the processing-core assignments to the characteristics or needs of the motion-control problem embodied in the motion control program.

In an example embodiment, a method performed by a computer system includes determining a division of task types among processing cores of a multicore processor in a motion control system. The task types are different types of program tasks in a motion control program targeted for execution by the motion control system and the division assigns two or more task types to respective processing cores of the multicore processor. Further, the method includes generating a configuration file embodying the division of task types and saving the configuration file in a memory or storage device, for processing by the motion control system that implements the motion control program.

In another example embodiment, a computer system comprises memory and processing circuitry. Based on the execution of computer program instructions stored in the memory, the processing circuitry is configured to determine a division of task types among processing cores of a multicore processor in a motion control system. The task types are different types of program tasks in a motion control program targeted for execution by the motion control system and the division assigns two or more task types to respective processing cores of the multicore processor. Further, the processing circuitry is configured to generate a configuration file embodying the division of task types and save the configuration file in the memory or storage device, for processing by the motion control system that implements the motion control program.

Of course, the present invention is not limited to the above features and advantages. Those of ordinary skill in the art will recognize additional features and advantages upon reading the following detailed description, and upon viewing the accompanying drawings.

### BRIEF DESCRIPTION OF THE DRAWINGS

FIG. 1 is a block diagram of a computer system according to one embodiment.

FIG. 2 is a block diagram of a motion control system according to one embodiment.

FIG. 3 is a block diagram of a method performed by a computer system according to one embodiment.

FIGS. 4A, 4B, 4C, 4D, and 4E are diagrams of a selection control according to one embodiment, for selecting a core management strategy for a motion control program executed by a motion control system.

### DETAILED DESCRIPTION

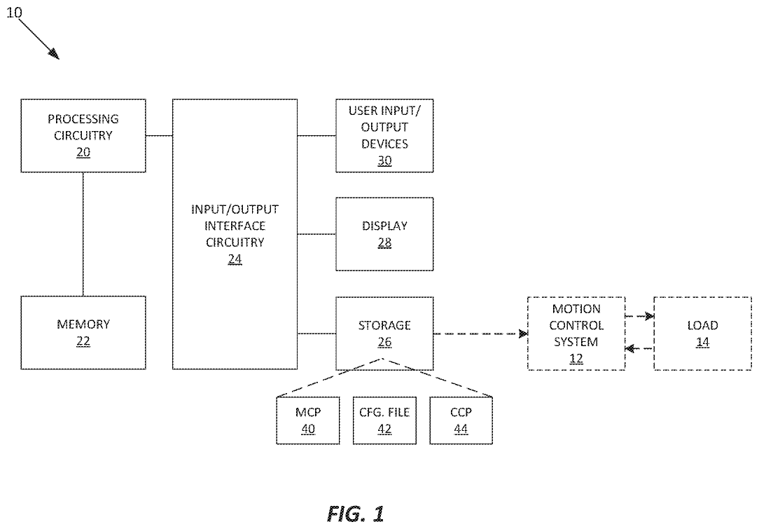

FIG. 1 illustrates a computer system 10 according to an embodiment of the techniques contemplated herein, with the understanding that the illustrated details are exemplary rather than limiting. The computer system 10 is associated with a motion control system 12, which controls a load 14. The “load” 14 comprises, for example, a machine having one or more movable parts involving one or more axes of motion, and the motion control system 12 generates the actuator output signals and processes the corresponding control feedback signals needed to move the machine under automated control.

While the computer system 10 may be implemented within the motion control system 12, the depiction provided in FIG. 1 aids discussion by illustrating example constituent parts or elements of the computer system 10. Those parts include processing circuitry 20, memory 22, and input/output (I/O) interface circuitry 24. Example devices or subsystems interfaced with the computer system 10 through the I/O interface circuitry 24 include one or more storage devices or systems 26, a display 28 for outputting textual or graphical information to a user of the computer system 10, and user input/output devices 30, such as a mouse and keyboard.

The computer system 10 in one or more embodiments generates a motion control program 40 (“MCP” in the diagram) for execution by the motion control system 12. Even in embodiments where the computer system 10 is not responsible for generating the motion control program 40, the computer system 10 is advantageously configured to generate a configuration file 42 (“CFG. FILE” in the diagram) for the motion control system 12. The configuration file 42 embodies a “core management strategy” to be used by the motion control system 12 for execution of the motion control program 40. Describing the computer system 10 as being configured to generate the configuration file 42 means, for example, that the computer system 10 is specially adapted to carry out the operations described herein based on its execution of stored program instructions, shown by way of example in FIG. 1 as a configuration control program 44 (“CCP” in the diagram).

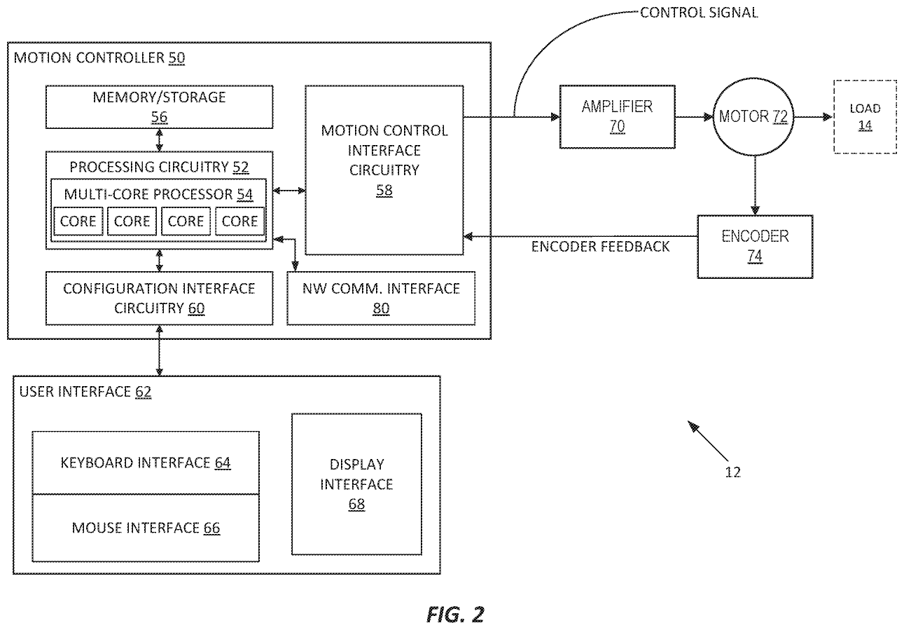

Again, the computer system 10 may be integrated into the motion control system 12, with FIG. 2 providing example details for a motion control system 12 in one or more embodiments. According to the example details, the motion control system 12 includes a motion controller 50 comprising processing circuitry 52 that includes one or more multi-core processors 54, memory/storage 56, motion-control interface circuitry 58, and configuration interface circuitry 60. With respect to embodiments where the motion control system 12 implements the functionality described herein for the computer system 10, the processing circuitry 52 of the motion control system 12 may function as described for the processing circuitry 20 of the computer system 10.

The motion-control interface circuitry 58 comprises, for example, one or more types of digital and/or analog interfaces for outputting one or more types of control signals for motion control and for receiving one or more types of feedback signals relating to the motion control. Such circuitry includes, for example, discrete digital I/O interfaces, digital-to-analog converters (DACs) for outputting analog signals, analog-to-digital converters (ADCs) for reading analog signals, Pulse-Width-Modulation (PWM) outputs, etc.

In more detail, the motion control interface circuitry 58 is configured to output one or more amplifier input signals, for input to an amplifier 70 that generates one or more amplifier output signals responsive to the amplifier input signals. The amplifier output signals control a motor 72 that provides rotary or linear motion to one or more machine parts that collectively form a load 14 that is controlled by the motion control system 12. An encoder 74 provides feedback from the motor 72 for use by the motion controller 50 in determining motor position and/or speed. Of course, the control scenario may be much more complex and there may be multiple amplifiers and motors and related feedback signals, e.g., for multi-axis motion control.

A user interface 62 is included in one or more embodiments of the motion control system 12 and comprises, for example, a keyboard interface 64, a mouse interface 66, and a display interface 68. In at least one embodiment, the motion control system 12 operates as the computer system 10 illustrated in FIG. 1, in addition to performing its motion control operations. In particular, in at least one embodiment, the motion control system 12 executes the aforementioned configuration control program 44, or an equivalent set of program instructions, to generate a configuration file 42 that embodies a core management strategy to be used by the motion control system 12 when executing the motion control program 40 on the one or more multi-core processors 54 of the motion control system 12.

As such, descriptions herein of a “computer system” being configured in a certain way or carrying out certain methods may be understood as referring to computer systems that are separate from the motion control system 12 or integrated into the motion control system 12. For ease of discussion and for clear distinction between execution/running of the motion control program 40 by the motion control system 12 for controlling the motion of the load 14 versus execution/running of the configuration control program 44 for configuring how the motion control system 12 divides tasks of the motion control program 40 across processing cores of its multi-core processor(s) 54, this disclosure makes separate reference to a “computer system 10” versus a “motion control system 12.” However, the reader should appreciate the contemplated possible integration of the functionality of the computer system 10 into the motion control system 12.

With the above framework in mind, an example computer system 10 comprises a processing circuitry 20 and associated memory 22, where the processing circuitry 20 comprises, for example, one or more microprocessors and associated supporting circuitry, such as crystal oscillators, watchdog timers, etc. Execution of computer program instructions stored in the memory 22 configures the processing circuitry 20 to determine a division of task types among processing cores of a multicore processor 54 in a motion control system 12, the task types being different types of program tasks in a motion control program 40 targeted for execution by the motion control system 12 and the division assigning two or more task types to respective processing cores of the multicore processor 54. As a non-limiting example, the multicore processor 54 comprises an LS1043A processor by NXP, which is multicore processor based on the ARM architecture and which includes four processing cores and associated caches, along with high-speed communication interfaces.

Further based on its execution of computer program instructions in the configuration control program 44, the processing circuitry 20 of the computer system 10 is configured to generate a configuration file 42 embodying the division of task types and save the configuration file 42 in the memory 22 or a storage device 26, for processing by the motion control system 12, which implements the motion control program 40 in question. Although the configuration file 42 comprises an actual file written out to the storage 26 in one or more embodiments, the term “configuration file” also encompasses data structures temporarily held in working memory, for example. Particularly in embodiments where the motion control system 12 is configured to operate as the computer system 10, the configuration file 42 is not necessarily written out to an external file system, at least not separately, and may be held within working memory for use when the motion control system 12 executes the motion control program 40. Alternatively, the configuration file 42 may be embodied in the motion control program 40, e.g., in header or library information.

Assigning different types or classes of program tasks to respective processing cores of a multicore processor 54 comprises, for example, making use of Application Programming Interface (API) functions provided by an operating system (OS) that provides a runtime environment on the motion control system 12, for execution of the motion control program 40. In particular, the API functions may include “affinity” functions that provide for the mapping of task types to respective ones of the processor cores. In at least one embodiment, the motion control system 12 restarts or reboots and executes startup code that reads the configuration file 42, which indicates the different core affinities of the different task types included in the motion control program 40.

To determine the division of task types in one or more embodiments, the processing circuitry 20 of the computer system 10 is configured to receive user input indicating a user-selected strategy for core management, from among a plurality of selectable strategies for core management. Each selectable strategy for core management defines a respective distribution of the task types among the processing cores of the multicore processor 54 of the motion control system 12. For example, to determine the division of task types in one or more embodiments, the processing circuitry 20 of the computer system 10 is configured to display, via a display 28 associated with the computer system 10, the selectable strategies for core management and receive the user input, via input/output interface circuitry 24 of the computer system 10, indicating the user-selected strategy for core management.

In other embodiments, or in other scenarios, to determine the division of task types, the processing circuitry 20 is configured to evaluate performance of the motion control program 40, either based on actual or simulated execution of the motion control program 40 on the multicore processor 54, and determine the division of task types based on the evaluated performance. In one or more example embodiments, the evaluated performance of the motion control program 40 indicates at least one of: processing core utilization during the actual or simulated execution of the motion control program 40 on the multicore processor 54 or task-execution timing violations, as defined by one or more performance requirements applicable to the motion control program 40, experienced during the actual or simulated execution of the motion control program 40 on the multicore processor 54.

The term “simulated execution” encompasses a machine-intelligence or neural-network-based processing of the motion control program 40. e.g., in programming-language form before compilation, or in a parameterized form, to estimate the number and/or “intensity” of operations associated with distinct types or classes of tasks embodied in the motion control program 40.

As a further alternative, the configuration control program 44 according to at least one embodiment includes program instructions that cause the computer system 10 to query a user for information about the motion control program 40—e.g., via a series of key questions aimed at characterizing the complexity and type of motion control, the nature of background or ancillary operations included in the motion control program 40, etc. The processing circuitry 20 uses the user-provided information to select a core management strategy or otherwise decide how the different types or classes (where “types” and “classes” have interchangeable meaning) of tasks embodied in the motion control program 40 are divided among the processing cores of the multicore processor(s) 54 of the motion control system 12. Such operations may be regarded as a “wizard” based approach to selecting a core management strategy.

In one or more embodiments, the task types comprise at least “servo-interrupt tasks” and “phase-interrupt tasks.” The servo-interrupt tasks are tasks executed at a first periodicity by the motion control system 12 for capturing feedback values reflecting a system state of the machine (load 14) being motion-controlled by the motion control system 12. The phase-interrupt tasks are tasks executed at a second periodicity by the motion control system 12 for updating motor commutation control outputs.

In at least one embodiment, the task types further comprise at least one of real-time-interrupt tasks, background tasks, and network communications tasks. The real-time interrupt tasks are tasks executed by the motion control system 12 for motion-planning calculations or status monitoring, and the background tasks are tasks executed by the motion control system 12 for operations that are in addition to the motion-control operations. The network communications tasks are tasks executed by the motion control system 12 for communicating on one or more network-communication interfaces 80 of the motion control system 12.

As another example, to determine the division of task types among the processing cores of the multicore processor 54 in the motion control system 12, the processing circuitry 20 of the computer system 10 is configured to logically divide the program tasks of the motion control program 40 into a plurality of classes, including at least a first class of tasks associated with acquiring motion-control feedback and a second class of tasks associated outputting motion-control values, and control the division of task types by class. Example task classes in one or more embodiments further include a third class of tasks associated with real-time safety and status monitoring by the motion control system 12, a fourth class of tasks associated with background operations of the motion control system 12 (e.g., user-programmed operations), and a fifth class of tasks associated with communications between the motion control system 12 and one or more other networked systems.

One aspect to consider here is that the task types or classes are defined with reference to the higher-level operational abstractions associated with the motion control program 40. That is, the task types or classes may be defined as tasks associated with outputting motion-control commands, tasks associated with acquiring (reading in) motion-control feedback data, tasks associated with path planning, also referred to as motion planning, tasks associated with ancillary or supporting operations that are not explicitly part of the motion-control operations. e.g., other control actions defined by an end-user with respect to overall operation of the motion control system 12, and tasks associated with network communications or other interfacing of the motion control system 12 with other devices or systems.

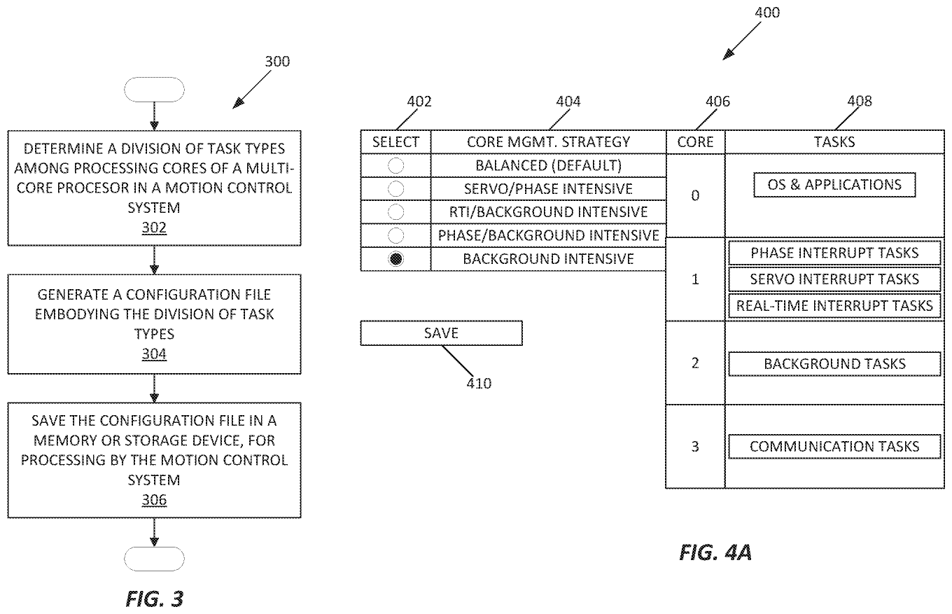

FIG. 3 illustrates a method 300 according to another embodiment. A computer system 10 performs the method 300, which includes determining (Block 302) a division of task types among processing cores of a multicore processor 54 in a motion control system 12, the task types being different types of program tasks in a motion control program 40 targeted for execution by the motion control system 12 and the division assigning two or more task types to respective processing cores of the multicore processor 54. Further, the method 300 includes generating (Block 304) a configuration file 42 embodying the division of task types and saving (Block 306) the configuration file 42 in a memory 22 or storage device 26, for processing by the motion control system 12 that implements the motion control program 40.

Determining the division of task type comprises, for example, receiving user input indicating a user-selected strategy for core management, from among a plurality of selectable strategies for core management. Each selectable strategy for core management defines a respective distribution of the task types among the processing cores of the multicore processor 54. Determining the division of task types in such embodiments may include displaying, via a display 28 associated with the computer system 10, the selectable strategies for core management and receiving the user input indicating the user-selected strategy for core management via input/output interface circuitry 24 associated with the computer system 10.

In another embodiment, determining the division of task types comprises evaluating performance of the motion control program 40, either based on actual or simulated execution of the motion control program 40 on the multicore processor 54, and determining the division of task types based on the evaluated performance. For example, the evaluated performance indicates at least one of: processing core utilization during the actual or simulated execution of the motion control program 40 on the multicore processor 54, or task-execution timing violations, as defined by one or more performance requirements applicable to the motion control program 40, experienced during the actual or simulated execution of the motion control program 40 on the multicore processor 54.

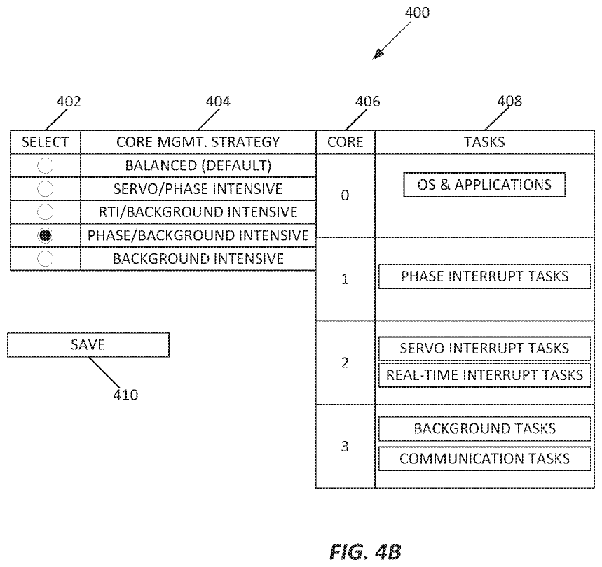

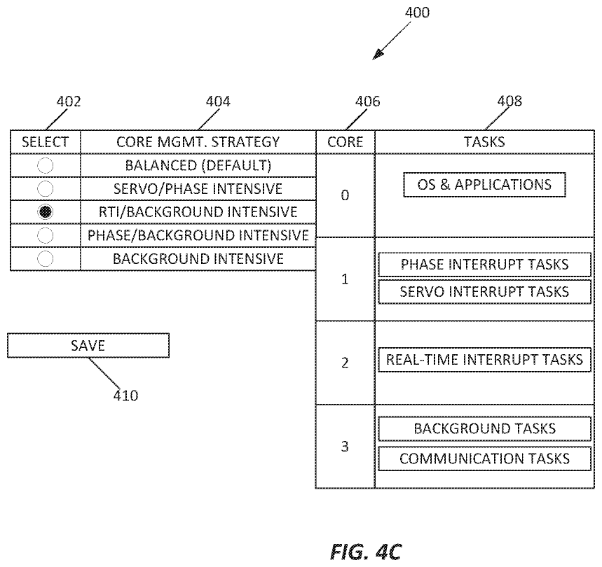

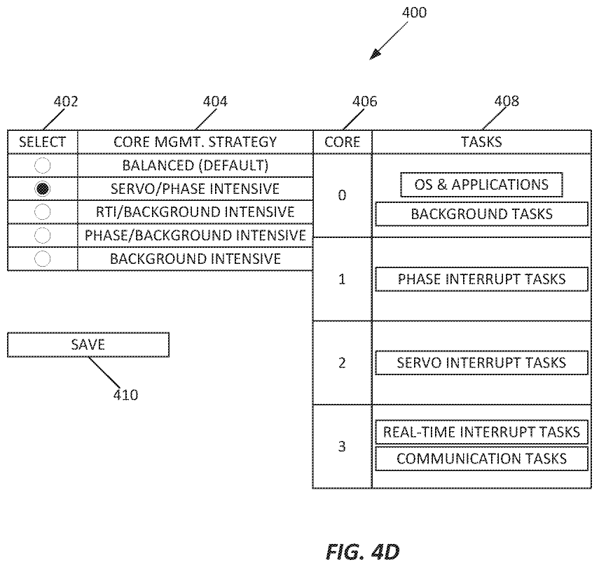

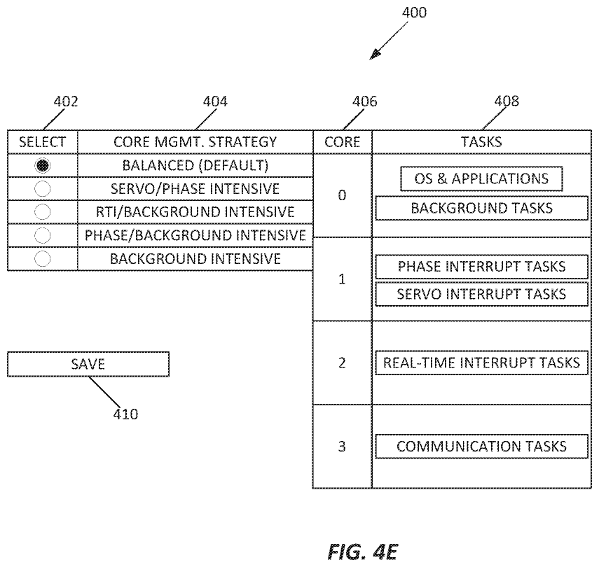

Dividing tasks at the program level provides an advantageous mechanism for ensuring that the processing cores of the multicore processor 54 are utilized in a way that complements the high-level (program-level) characteristics of the motion control program 40. FIGS. 4A, 4B, 4C, 4D, and 4E provide example details for task divisions and core management strategies in the context of one or more embodiments.

FIG. 4A illustrates an example graphical control 400 generated or otherwise depicted on a display 28 of the computer system 10, based on execution of the configuration control program 44 by the processing circuitry 20 of the computer system 10. The graphic control 400 includes several elements, one or more of which are informational elements for conveying information to the user and one or more of which are control elements for receiving a user input indicating a desired core management strategy from among a plurality of defined core management strategies. Here, “core management strategy” refers to how different types of program tasks embodied in the motion control program 40 are divided among the processing cores of the multicore processor 54 of the motion control system 12.

For example, the graphical control 400 includes a selection control 402 comprising, for example, a set of “radio buttons” or other input-selection controls allowing the user to indicate a preferred core management strategy among a defined set of core management strategies depicted in a management strategy column 404. A core column 406 lists the multiple processing cores of the multicore processor 54 and a task column 408 shows the task-to-core assignments. That is, the task column 408 shows the task types that are associated with each of the respective processing cores of the multicore processor 54 for the currently-selected core management strategy.

The configuration control program 44 includes program instructions that cause the processing circuitry 20 to dynamically update the task column 408 responsive to the user selecting one of the core management strategies via the selection control 402. A save control 410 allows the user to save the selected core management strategy.

In the example of FIGS. 4A, 4B, 4C, 4D, and 4E, the core management strategies are: Balanced. Servo/Phase Intensive, RTI/Background Intensive, Phase/Background Intensive. and Background Intensive. Here. “RTI” denotes “real-time interrupt. The Balanced strategy may be the default selection, in one or more embodiments.

FIG. 4A shows the task divisions resulting from the selection of the Background Intensive strategy, which results in the following division of task types of the motion control program 40 among the processing cores of the multicore processor 54: phase interrupt tasks, servo interrupt tasks, and real-time interrupt tasks assigned to Core 1, background tasks assigned to Core 2, and communication tasks, such as EtherCat communications tasks, assigned to Core 3. The OS and associated applications may be linked to Core 0 or another specific core, outside the control of the configuration control program 44.

FIG. 4B illustrates a case where the user selected the Phase/Background Intensive core management strategy, which results in the following division of task types of the motion control program 40 among the processing cores of the multicore processor 54: phase interrupt tasks assigned to Core 1, servo interrupt tasks and real-time interrupt tasks assigned to Core 2, and background tasks and communication tasks assigned to Core 3. This assignment strategy provides one core for phase-intensive tasks with no other task types assigned to that core, and provides another core for background tasks, where that core may be shared with other types of tasks that may not impose high computational burdens (such as communication-type tasks).

FIG. 4C illustrates a case where the user selected the RTI/Background Intensive core management strategy. The selection results in the following division of task types of the motion control program 40 among the processing cores of the multicore processor 54: phase interrupt tasks and servo interrupt tasks assigned to Core 1, real-time interrupt tasks assigned to Core 2, and background tasks and communication tasks assigned to Core 3. This approach provides one core for real-time interrupt type tasks, such as path-planning computations, with no other task types assigned to that core.

FIG. 4D illustrates a case where the user selected the Servo/Phase Intensive core management strategy, which results in the following division of task types of the motion control program 40 among the processing cores of the multicore processor 54: background tasks assigned to Core 0, phase interrupt tasks assigned to Core 1, servo interrupt tasks assigned to Core 2, and real-time interrupt tasks and communication tasks assigned to Core 3. This core management strategy complements instances where the motion control program 40 is intensive both with respect to phase interrupt tasks and servo interrupt tasks, because it assigns the phase interrupt tasks to one core to which no other task types are assigned and assigns the servo interrupt tasks to another core to which no other task types are assigned.

FIG. 4E illustrates a case where the user selected the Balanced core management strategy, which results in the following division of task types of the motion control program 40 among the processing cores of the multicore processor 54: background tasks assigned to Core 0, phase interrupt tasks and servo interrupt tasks assigned to Core 1, real-time interrupt tasks assigned to Core 2, and communication tasks assigned to Core 3.

The Balanced core management strategy may complement a relatively wide range of motion control program characteristics, e.g., 80% of motion control programs, and may, therefore, be set as the default choice. The other core management strategies are then used in cases where the motion control program 40 deviates from the typical case covered by the Balanced core management strategy. For example, if the motion control program 40 is targeted at controlling multiple commutated axes, the Servo/Phase Intensive core management strategy is a better choice, because the number/load of servo-interrupt and phase-interrupt tasks increases with the number of control axes of motion.

In a scenario where the motion control program 40 involves sophisticated inverse kinematics, the RTI/Background intensive core management strategy may be the best choice, as it assigns the real-time interrupt tasks to a processor core to which no other tasks are assigned. In this context, the real-time interrupt tasks are associated with the motion-planning computations that feature prominently in motion-control scenarios involving sophisticated inverse kinematics.

In at least one embodiment, rather than providing users with a limited selection of defined core management strategies, the configuration control program 44 may cause the computer system 10 to display the full set of individual task types, among a defined universe of task types, and allow the user to assign individual ones of the different task types to a processing core of the user's choice. Such an approach allows something of an ad hoc approach to core management strategy, but it provides experienced users with tremendous flexibility in choosing how different types of motion control program tasks are assigned to the respective cores of a multicore processor 54.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

What is claimed is:

1. A method performed by a computer system, the method comprising:
determining a division of task types among processing cores of a multicore processor in a motion control system, the task types being different types of program tasks in a motion control program targeted for execution by the motion control system and the division assigning two or more task types to respective processing cores of the multicore processor;
generating a configuration file embodying the division of task types; and
saving the configuration file in a memory or storage device, for processing by the motion control system that implements the motion control program.

2. The method of claim 1, wherein determining the division of task type comprises receiving user input indicating a user-selected strategy for core management, from among a plurality of selectable strategies for core management, each selectable strategy for core management defining a respective distribution of the task types among the processing cores of the multicore processor.

3. The method of claim 2, wherein determining the division of task types further comprises displaying, via a display associated with the computer system, the selectable strategies for core management and receiving the user input indicating the user-selected strategy for core management via input/output interface circuitry associated with the computer system.

4. The method of claim 1, wherein determining the division of task types comprises evaluating performance of the motion control program, either based on actual or simulated execution of the motion control program on the multicore processor, and determining the division of task types based on the evaluated performance.

5. The method of claim 4, wherein the evaluated performance indicates at least one of:
processing core utilization during the actual or simulated execution of the motion control program on the multicore processor; or
task-execution timing violations, as defined by one or more performance requirements applicable to the motion control program, experienced during the actual or simulated execution of the motion control program on the multicore processor.

6. The method of claim 1, wherein the task types comprise at least servo-interrupt tasks and phase-interrupt tasks, wherein the servo-interrupt tasks are tasks executed at a first periodicity by the motion control system for capturing feedback values reflecting a system state of a machine being motion-controlled by the motion control system, and wherein the phase-interrupt tasks are tasks executed at a second periodicity by the motion control system for updating motor commutation control outputs.

7. The method of claim 6, wherein the task types further comprise at least one of real-time-interrupt tasks, background tasks, and network communications tasks, wherein the real-time interrupt tasks are tasks executed by the motion control system for motion-planning calculations or status monitoring, wherein the background tasks are tasks executed by the motion control system for operations that are in addition to motion-control operations, and wherein the network communications tasks are tasks executed by the motion control system for communicating on one or more network-communication interfaces.

8. The method of claim 1, wherein determining the division of task types among the processing cores of the multicore processor in the motion control system depends on logically dividing the program tasks of the motion control program into a plurality of classes, including at least a first class of tasks associated with acquiring motion-control feedback and a second class of tasks associated outputting motion-control values, and controlling the division of task types by class.

9. The method of claim 8, wherein the plurality of classes further includes a third class of tasks associated with real-time safety and status monitoring by the motion control system, a fourth class of tasks associated with background operations of the motion control system, and a fifth class of tasks associated with communications between the motion control system and one or more other networked systems.

10. A computer system comprising:
memory; and
processing circuitry configured, based on the execution of computer program instructions stored in the memory, to:
determine a division of task types among processing cores of a multicore processor in a motion control system, the task types being different types of program tasks in a motion control program targeted for execution by the motion control system and the division assigning two or more task types to respective processing cores of the multicore processor;
generate a configuration file embodying the division of task types; and
save the configuration file in the memory or storage device, for processing by the motion control system that implements the motion control program.

11. The computer system of claim 10, wherein, to determine the division of task types, the processing circuitry is configured to receive user input indicating a user-selected strategy for core management, from among a plurality of selectable strategies for core management, each selectable strategy for core management defining a respective distribution of the task types among the processing cores of the multicore processor.

12. The computer system of claim 11, wherein, to determine the division of task types, the processing circuitry is configured to display, via a display associated with the computer system, the selectable strategies for core management and receive the user input, via input/output interface circuitry of the computer system, indicating the user-selected strategy for core management.

13. The computer system of claim 10, wherein, to determine the division of task types, the processing circuitry is configured to evaluate performance of the motion control program, either based on actual or simulated execution of the motion control program on the multicore processor, and determine the division of task types based on the evaluated performance.

14. The computer system of claim 13, wherein the evaluated performance indicates at least one of:
processing core utilization during the actual or simulated execution of the motion control program on the multicore processor; or
task-execution timing violations, as defined by one or more performance requirements applicable to the motion control program, experienced during the actual or simulated execution of the motion control program on the multicore processor.

15. The computer system of claim 10, wherein the task types comprise at least servo-interrupt tasks and phase-interrupt tasks, wherein the servo-interrupt tasks are tasks executed at a first periodicity by the motion control system for capturing feedback values reflecting a system state of a machine being motion-controlled by the motion control system, and wherein the phase-interrupt tasks are tasks executed at a second periodicity by the motion control system for updating motor commutation control outputs.

16. The computer system of claim 15, wherein the task types further comprise at least one of real-time-interrupt tasks, background tasks, and network communications tasks, wherein the real-time interrupt tasks are tasks executed by the motion control system for motion-planning calculations or status monitoring, wherein the background tasks are tasks executed by the motion control system for operations that are in addition to motion-control operations, and wherein the network communications tasks are tasks executed by the motion control system for communicating on one or more network-communication interfaces.

17. The computer system of claim 10, wherein, to determine the division of task types among the processing cores of the multicore processor in the motion control system, the processing circuitry is configured to logically divide the program tasks of the motion control program into a plurality of classes, including at least a first class of tasks associated with acquiring motion-control feedback and a second class of tasks associated outputting motion-control values, and control the division of task types by class.

18. The computer system of claim 17, wherein the plurality of classes further includes a third class of tasks associated with real-time safety and status monitoring by the motion control system, a fourth class of tasks associated with background operations of the motion control system, and a fifth class of tasks associated with communications between the motion control system and one or more other networked systems.
